(19) United States
(12) Patent Application Publication
(10) Pub. No.: US 2018/0302690 A1
(43) Pub. Date: Oct. 18, 2018

(54) A SYSTEM FOR INSERTING A MARK INTO A VIDEO CONTENT

(71) Applicant: NAGRAVISION S.A., Cheseaux-sur-Lausanne (CH)

(72) Inventors: Minh Son TRAN, Bourg la Reine (FR); Yishan ZHAO, Antony (FR); Pierre SARDA, Echallens (CH)

(21) Appl. No.: 15/767,874

(22) PCT Filed: Oct. 3, 2016
(86) PCT No.: PCT/EP2016/073533

§ 371 Date: Apr. 12, 2018

(30) Foreign Application Priority Data
Oct. 15, 2015 (EP) 15189913.5

(51) Int. Cl. H04N 21/8358; G06T 1/00; H04N 21/435

(52) U.S. Cl. CPC H04N 21/8358; H04N 21/435; G06T 1/0028

(57) ABSTRACT

The present invention relates to a system and a method for reliably including a fingerprint or a watermark in a digital media content. In order to endure that the marking process will not be bypassed, the disclosed method includes insertion of the mark when the content is in compressed format. The disclosure covers ways and means for simplifying the process of including visible or invisible marks in the content using on-screen overlay techniques.

### TECHNICAL DOMAIN

The present disclosure generally relates to the domain of video content marking. Video content marking may be done to allow for the source of a piece of video content to be traced at certain points throughout the video distribution chain.

### STATE OF THE ART

Recent evolution in capacities of multimedia hardware at affordable prices opens up huge possibilities for unauthorised third parties to redistribute video contents—even when such content is protected under encryption means. Technologies exist whereby media content may be marked in order that the content may be traceable either to the original content owner or distributor or to a third party who leaks the content, usually without informing the original content owner or distributor. Such technologies may also be used as a compliment to known encryption techniques.

Whereas media encryption may be said to provide proactive protection by limiting access as far as possible to the media in question, marking of media content can be said provide a reactive means of providing protection to the content since marking renders a particular content traceable should any proactive protection techniques fail, thereby allowing the content to fall into the control of malicious third parties.

Although pertaining to the same domain of embedding information into a host content, a distinction is to be made between two types of marking technique: watermarking and fingerprinting. When content is marked by watermarking methods, this renders the content traceable usually to the content owner or to the original, or otherwise authorised, distributor of the content. Watermarking techniques involve inserting a mark into the content, where the mark is based on an identifier traceable to the owner or authorised distributor. On the other hand, when content is marked using fingerprinting techniques, the inserted mark is usually based on an identifier allowing for the intended original recipient of the content to be traced. Fingerprinting techniques therefore render re-distributed content traceable, usually to its originally intended recipient. It would then be reasonable to assume that this traced source is an unauthorised re-distributor.

Content owners who employ marking techniques usually deploy monitoring means in the field in order to receive content in the same way that any other user would receive (re-)distributed content. By receiving content in this way, should such content be marked content, the monitors (or their agents) can analyse all or part of the content and/or its mark to allow either the owner or authorised distributor of the content to be determined or an unauthorised re-distributor of the content to be traced.

The state of the art includes systems and methods for inserting a mark into media content just before it is consumed by the user. This involves processing the content to be marked while such content is in its raw, uncompressed state. In the case where the media content is a video, inserting a mark in this manner may involve modifying the data at the level of the display memory buffer, just before the data which is held in the buffer is presented for rendering to a display. State of the art systems which are configured to perform such operations are known and include those which are configured to provide on-screen display functionality (OSD). Such systems usually include an OSD insertion module and form part of what is generally known as graphics overlay systems, largely supported in modern rendering systems at a middleware or hardware level. OSD insertion modules generally include additional information over and above the content to be displayed, such information being included in an overlay fashion, visible on top of or mixed with the content. Examples of this are a subtitle text, a control menu or control icons such as a volume slider.

Known, rather straightforward, OSD insertion techniques can be used to insert a mark, such as a watermark, into a media content. Without exception, even if content is distributed in encrypted and compressed form, there comes a point in the distribution chain where the content has to appear in decrypted, decompressed form. This point may be at the input of the OSD unit, for example. Embedding the mark at this point facilitates the control of the level of visibility of the mark: raw video is well perceived by the human eye and so the direct processing of raw video to insert the mark allows for the result to be easily inspected in order to control the level of distortion caused by the mark insertion without resorting to any complex transformation techniques. It is therefore convenient to use this point as a point for performing the insertion of the mark. Alternatively, this point may be at the output of the media decoder, where credential information required to form a watermark (for example, user ID and/or operator identification) is no longer available. Such information is usually incorporated in the descrambling phase, occurring far earlier in the chain, well before the media decoder stage. For this reason, a securely reinforced transmission means is required to feed such crucial information to the OSD insertion module before the content is rendered. In some systems, even those which incorporate such securely reinforced transmission means, pirates can simply disable the OSD chipset thereby thwarting any attempt at providing mark insertion security features.

In the state of the art, when referring to media content which is video, the terms visible mark and invisible mark are used to mean content which has been marked in a way which renders the mark perceptible to a human eye, or marked in a way which renders the mark substantially imperceptible to the human eye, respectively. These terms (visible and invisible) are extended to cover other types of media content such as audio content or printable content (documents). The terms visible and invisible are taken to mean perceptible and imperceptible. An invisible mark leaves its related content substantially unaltered to the extent that its presence is not perceptible to a consumer of the content who is not specially prepared to look for the mark. A visible mark usually alters its related content in a way which renders the mark perceptible to a consumer of the content. It is to be understood therefore that the terms visible and invisible, as used in the present disclosure, relate to the level of perceptibility of a mark introduced into the content when such marked content is consumed in a way which is compatible with the way in which its corresponding unmarked content is intended to be consumed. For example, a mark in an audio content is invisible if a listener cannot tell that what he or she hears when listening to the marked content would be any different should the content not have been marked. Ideally then the listener would hear no difference between the marked and unmarked contents. Similarly, if the content were video content, then the viewer would not be able to see a difference between watching content which includes an invisible mark and watching a corresponding unmarked (equivalent) content.

For a content owner who decides to use watermarking or fingerprinting techniques in protecting his or her content, certain advantage is to be gained should the content owner choose to use invisible marking techniques, since a malicious third party intent on defeating a watermark or fingerprint will be less inclined to try to remove a mark if he or she is not aware that a mark is present. Care is sometimes taken when using the OSD techniques for including marks in content, that such marks when included do not disrupt the experience of the user in a way which attracts the user's attention to the mark. Arranging for marks to be invisible in this way using OSD techniques on the raw media content is relatively straightforward. Techniques also exist in the state of the art for including the mark in the content when the content is in its compressed state, but more care has to be taken to make sure that the mark is not visible in the raw domain. Advantage is to be gained from being able to perform the marking in the compressed domain because the content owner does not have to rely on trusting that the mark will be properly implemented on the client side. For example, an ill-intentioned third party could find a way to simply eliminate or otherwise bypass the OSD insertion function on the raw media content just before it is presented for display.

Marking of content in the compressed domain may be done either at the server side or within a trusted environment, such as within a security module, on the client side. In this way an ill-intentioned user cannot bypass the marking phase. In order to ensure that a mark does not seriously disrupt the final result when the marked content is presented to the consumer, state of the art systems which employ compressed domain marking therefore generally use techniques which involve modifying the discrete cosine transform (DCT) coefficients at high spectral frequencies of the compressed content.

Another state of the art technique for marking media content is disclosed in European Patent Application Publication number EP13175253, filed by the Applicant of the present invention. The technique described in this document includes preparing two different copies of the content to be protected at two different bit-rates. When a user requests the content, the content is sent chunk by chunk to the user, where each chunk is selected from either one or other of the bit-rates. When this selection is based on an identifier of the user it allows for the user to be traced should that content be re-distributed and picked up by a receiver which is adapted to analyse the content by inspecting the bit-rates of the chunks used to make up the content. This technique of course may also be said to provide for mark insertion in the compressed domain.

All of the known techniques which involve mark insertion in the compressed domain can be considered to be relatively complex. In some cases an entropy decoder is required to be able to retrieve the DCT coefficients, while an entropy decoder is also required in order to reintegrate the modified DCT coefficients into the marked (compressed) content. In other cases, such as in EP13175253 above, a second encoded version of the same content has to be prepared in advance, which leads to additional delay and extra storage capacity.

### BRIEF SUMMARY OF THE INVENTION

Marking of media content can be described as being a reactive content protection technique, which when used in combination with proactive content protection techniques, such as encryption or other conditional access techniques, requires that the secured path for exchange of credential information be properly taken into consideration. State of the art techniques for inserting marks into media content typically do not adequately address these issues. For example, in conditional access systems, the descrambling unit or the security module, which may be considered to be the central unit of a conditional access module, usually provides for secure storage of user identifications or access rights or other credential information associated with the protected content. In order to guarantee the secured path, either an additional transcoder needs to be added within the secure environment surrounding the descrambling or the credentials need to be communicated via a separate secure path to the media decoder unit where its entropy decoder can be reused for marking purposes. For example, in the marking technique where DCT coefficients are modified, all or part of the information used to generate the mark must be securely fed to the entropy decoder. In any case, the additional effort of either providing a further entropy decoder or providing an additional secured path has an important implication on the structure of the marking system and on the cost of the end device.

Given the state of the art in the domain of watermarking or fingerprinting of media content, there remains a need to simplify the marking of video content in the compressed domain while securing the delivery of credential information to the mark insertion module. The present disclosure describes ways and means to achieve these goals.

Invisible marks are generally more robust than visible marks in the sense that an unsuspecting consumer will not be inclined to employ measures to counter the presence of the mark if he or she doesn't perceive it. Visible marks are easier (less costly) to implement but their visibility may provide encouragement to a malicious user to attempt to remove them. On the other hand, the implementation of invisible marks is costly in terms of processing and bandwidth. Furthermore, when the mark is inserted into the content while the content is in a compressed state, for example to improve security in the enforcement of the insertion of the mark, a lot more effort has to be made to ensure that the mark is invisible or at least does not excessively perturb the final output (for non-malicious end users). Insertion of an invisible mark usually requires a comprehensive analysis of the source content as well as a complex detection process. This is generally not trivial and indeed may not be feasible in all situations. Embodiments of the present disclosure address these issues, rendering invisible marking accessible with low complexity and cost.

Visible marks have an advantage over their invisible counterparts however in the sense that their detection can be performed quite easily.

To this end, according to a first aspect, the present disclosure presents system for inserting at least one marking point into a video content, the marking point having a spatial position within a frame of the video content, the system comprising one or more modules including an insertion module for inserting the marking point into a compressed bitstream of the video content;
wherein the compressed bitstream of the video comprises at least one frame of the video content, the frame being divided into one or more slices each representing spatially distinct regions of the frame, each slice being encoded into an independently decodable unit, each slice having a spatial position within its frame, the spatial position of the slice being given by at least part of a header portion of the independently decodable unit; characterised in that:
the marking point corresponds to an independently decodable marking unit in the compressed bitstream of the video content, the independently decodable marking unit having a header portion, the insertion module being configured to insert the independently decodable marking unit having a header portion at least part of which gives a spatial position of a marking slice, and to edit the header portion of the independently decodable marking unit based at least on the spatial position of the marking point.

Video content compressed as described in the preamble of the above statement may be compressed according to an H.264 video coding standard for example, in which case the independently decodable unit is a NALU (network abstract layer unit), having a spatial position within its frame, the spatial position being given by a part of the header of the NALU. according to embodiments of the invention, there is disclosed a marking unit or marking NALU (MNALU), which has the same format and conforms to the same requirements of the video coding standard as does the NALU, where the marking unit also has a header, part of which gives the spatial position of the MNALU within its frame.

According to a second aspect, there is disclosed a propagated signal comprising a bitstream representative of one or more frames of video content, the bitstream being compressed according to a video coding scheme in which at least one spatially distinct contiguous region of a video frame is comprised within a network abstraction layer unit within the bitstream; characterised in that:
at least one frame of video decodable from at least part of the bitstream of compressed video content comprises a marking point corresponding to a marking network abstraction layer unit within the bitstream, the marking point having a spatial position in its frame which corresponds to a spatial position of part of a predetermined mark pattern.

Since a propagated signal is a machine-generated signal, the signal being electrical, optical, or electromagnetic, it follows that this aspect may also cover a machine for generating such a propagated signal, the machine comprising an insertion module as described in the present disclosure.

According to a third aspect, disclosure is made relative to a method for causing at least one marking point to be overlaid onto a video image comprising one or more video frames divisible into one or more video slices, the marking point having a spatial position within its respective video frame, comprising:
inserting at least one marking unit into a bitstream corresponding to the video image, the bitstream being compressed according to a video coding scheme in which at least one spatially distinct contiguous region of the video frame is comprised within a network abstraction layer unit having a header comprising a spatial position of part of the video image and a payload comprising one or more macroblocks of the video image, the marking unit having a header comprising the spatial position of the marking point and a payload comprising at least one macroblock of the marking point.

Advantage is to be gained from marking content in the compressed domain, since this eliminates the need to perform any transcoding before performing the mark insertion. Thus, any extra system complexity or delay and resulting loss of quality due to the addition of the transcoding step is avoided. This is of particular significance when marking is to be performed at a point which may be considered to be simply a transit point within a network, such as a home gateway device in part of a home media centre. The home gateway device generally functions as an intermediary device for forwarding content to end devices such as PCs, smartphones and the like, where the content will actually be processed, usually for consumption by a user. The home gateway device is also a convenient place for marking of the content before it is delivered to the end device and so it is advantageous to be able to insert the mark into the content directly in the compressed domain without having to perform any transcoding at the home gateway device.

### BRIEF DESCRIPTION OF THE DRAWINGS

The present invention will be better understood thanks to the detailed description which follows and the accompanying drawings, some of which include non-limiting examples of embodiments of the invention, namely:

FIG. 1, which is a representation of a display which shows a mark comprising 5-marking points directly overlaid onto a displayed image using state of the art on-screen-display (OSD) insertion techniques;

FIG. 2, schematically representing a media player in which an embodiment of the present invention may be deployed;

FIG. 3, showing a video frame including a mark comprising three marking points resulting from the inclusion of three marking units inserted using OSD-like insertion methods according to embodiments of the present invention;

FIG. 4, showing a system in which an embodiment of the present may be deployed, the system comprising a server and a media player;

FIG. 5a, showing the structure of a network abstraction layer unit according to an advanced video coding standard;

FIG. 5b, showing the structure of a slice of video content comprised in a network abstraction layer unit, the video slice comprising a plurality of macroblocks of video content;

FIG. 6, showing part of a bitstream comprising two NALUs, which has been modified to include two marking units according to an embodiment of the present invention and how a corresponding mark comprising two marking points might appear within a video frame;

FIG. 7, illustrating a part of a bitstream of compressed video which has been marked according to an embodiment of the present invention;

FIG. 8, illustrating a method, according to an embodiment of the present invention, for marking video content with an identifier, where the identifier is spread over a plurality of video frames.

### DETAILED DESCRIPTION

In the context of the present description, reference may be made to a computer readable medium. The computer readable medium may be transitory, including, but not limited to, propagating or otherwise propagated electrical or electromechanical signals or any composition of matter generating or receiving such signals. The computer readable medium may be non-transitory, including, but not limited to volatile or non-volatile computer memory or machine readable storage devices or storage substrates such as hard disc, floppy disc, USB drive, CD, media cards, register memory, processor caches, random-access memory, etc. The computer readable medium may be a combination of one or more of the above.

A propagated signal is an artificially generated signal, e.g., a machine-generated electrical, optical, or electromagnetic signal, which is generated to encode information.

Functional operations and modules described in this document can be implemented in analogue or digital electronic circuitry or in computer software, firmware or hardware, or in combinations thereof. The functional operations or modules may include one or more structures disclosed in the present document and their structural equivalents or in combinations of one or more of them.

The disclosed and other embodiments may be implemented as one or more computer programme products, where a computer programme product is taken to mean one or more modules of computer programme instructions encoded on a computer readable medium for execution by, or to control the operation of, data processing apparatus.

Apparatus for performing processes on data encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The techniques and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

In the domain of watermarking or fingerprinting of digital media content, a mark is said to visible or perceptible if a consumer can discern the presence of the mark when consuming the content in the manner in which it was intended to be consumed. In other words, if the content were video content, then a mark in the video content (fingerprint or watermark) would be said to be visible if a viewer of the content were able to perceive or otherwise discern the presence of the mark while the viewer was watching the video content on a display.

Detection of marks is usually a process which is performed by the content owner who includes data into the medium which comprises the consumable content, over and above the consumable content, which would allow either the content owner or an intended recipient of the content to be traced. The content owner may also deploy one or more receivers to intercept a pirated copy of his or her content and may further employ equipment which is particularly adapted to analyse the content on an electronic level or on a manual basis in order to extract and decode the mark from the content. Detection may be done using technical means other than those which would be required for simple consumption of the content or using manual means (aural or visual, for example) compatible with those which would be required for simple consumption of the content.

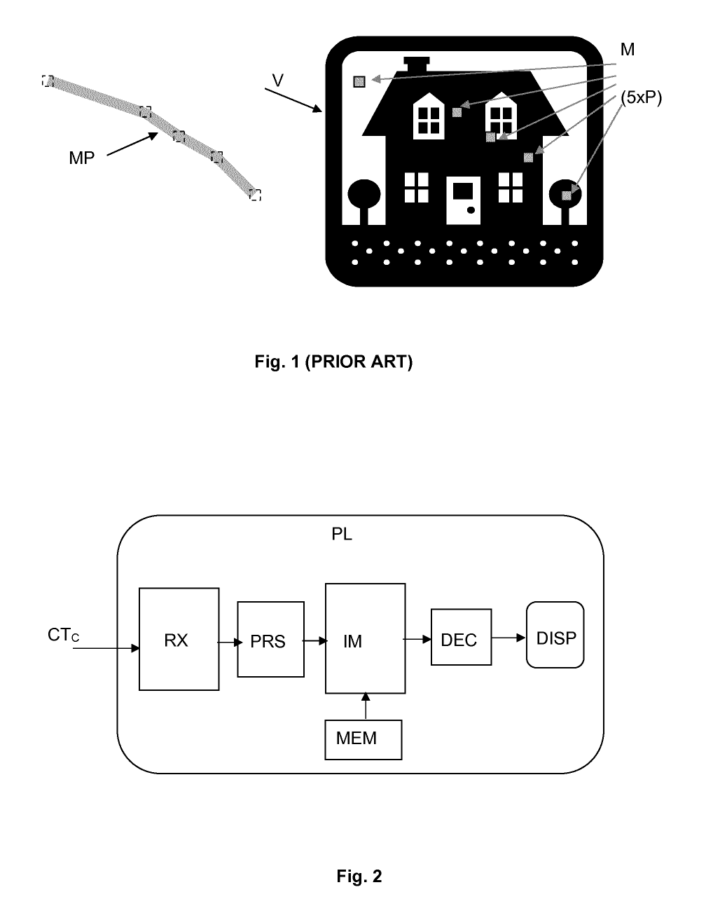

The state of the art includes techniques for inserting a visible mark, representative of a predetermined mark pattern, into video content using On-Screen Display (OSD) insertion techniques to overlay a marking point or a series of marking points, on a pixel by pixel basis (or group of pixels by group of pixels basis), onto the video to be displayed depending on the required mark pattern which has to appear on the final image. FIG. 1 illustrates a display of a picture which has been processed by an OSD insertion module to overlay a mark (M) comprising five marking points (P) onto a number of frames of a video picture (V). By a marking point (P) it is meant a feature which can be displayed to represent a finite part of the predetermined mark pattern (MP). Each of the five marking points in FIG. 1 is a grey square shape. Obviously the more marking points (P) that are used to represent the predetermined mark pattern (MP) the closer the resemblance between the resulting displayed mark (M) and the predetermined mark pattern (MP). The example of FIG. 1 illustrates a mark pattern which is a line, approximated as an inserted mark comprising five square-shaped marking points spatially positioned to display a representation of the line. Instead of being a line, the mark pattern could be a set of discreet square shapes, in which case it could be arranged for the displayed mark to be an exact, or substantially perfect, representation of the predetermined mark pattern. When the predetermined mark pattern is text, such as a word comprising one or more characters, each of the marking points may be a text character spatially positioned so that the mark displays the word of the predetermined mark pattern. OSD insertion modules are typically used to perform this type of function and typical applications include providing subtitle text, displaying a control menu or a control parameter graphic, which are exemplary typical targets for OSD treatment. Here, the mark can be considered to be the subtitle text, the control menu or the control parameter graphic. This type of overlay technique, usually using an OSD insertion module, is therefore a straightforward way to insert a visible mark over an uncompressed video content, usually by overlaying the mark pattern directly at the level of the display buffer data.

Once it has been decided how a mark pattern should appear on a picture, the mark pattern can be resolved into a number of marking points which will represent or otherwise approximate the mark pattern when it is displayed on a display device. Various different ways of describing the positions of each marking point is possible, such as by x-y Cartesian coordinates. Another way is to divide the screen into a number of macroblock positions, for example in a raster scan fashion, going from left to right and top to bottom of the screen. A marking point appearing at a position of a macroblock at top left of the screen would then have a position number 1, while another marking point somewhere farther down the screen may have a position number 67, meaning the position where the 67^{th} macroblock would be. It is therefore conceivable to programme a computing device to translate any mark pattern into one or more marking points having spatial positions corresponding to a macroblock position nearest the spatial position where the marking point lies. In this manner any conceivable marking pattern can be resolved to give the predetermined positions of its constitutive marking points.

As discussed above, it would be conceivable for a malicious third party to bypass a watermarking or fingerprinting process which employs such simple OSD overlay techniques because they are usually performed on the raw uncompressed media just before being sent to the display device. The present disclosure therefore deals with methods and systems for inserting watermarks or fingerprints into the content in the compressed domain where a content owner still has control over how his or her content will be displayed. The content owner still has control because he or she usually has control over the secure environment surrounding the descrambling unit. Conventional OSD overlay techniques are not usually suitable for inserting marks in the compressed domain because the input frame of the compressed video data is no longer a simple two-dimensional array of pixels as is the case in the raw domain. It is disclosed herein that techniques similar to the known OSD overlay principle can still be used advantageously to insert marks into compressed video, thereby providing a simple and secure method for inserting visible (or even invisible) marks with robust enforcement.

Video content suitable for transformation to the compressed domain is generally represented as a series of still image frames. The frames are made up of substantially square-shaped groups of neighbouring pixels called macroblocks. Video compression techniques aim to express differences between macroblocks from frame to frame in efficiently compact forms. The resulting compressed frames can be intraframes, which include all data required to describe an image, or they can be interframes, which require information from previous frames or from future frames in order to describe an image. Intraframes are known as I-Frames and they are the least compressed, while Interframes, including P-Frames and B-Frames are among the most compressed because they can use previous or future frames to derive the common essential information. Hence the P-frames and the B-frames need carry only a small amount of information to describe the difference with respect to its respective common essential information. These compressed frames form an abstraction of the compressed video content, usually referred to as being the Video Coding Layer (VCL). The VCL is specified to efficiently represent the content of the video data.

Most so-called advanced video coding standards further encapsulate the compressed content at a higher level of abstraction, thus providing more flexibility for use in a wide variety of network environments. Most advanced video coding standards provide a means for coding compressed video in a way which is network-friendly by describing the data packetising at a network abstraction layer. This allows the same video syntax to be used in many different network environments, meaning that advanced video coding standards s are designed to be network-friendly. In some advanced video coding standards these abstractions are known as the video coding layer and the network abstraction layer. The network abstraction layer is specified to format the video data (represented by the VCL) and provide header information in a manner appropriate for conveyance of a variety of communication channels or storage media. Network abstraction layer data is composed of a plurality of special units, sometimes known as network abstraction layer units, which in turn consist of partial or full compressed frames encapsulated with header information in a manner appropriate for conveyance of a variety of communication channels of storage media.

The network friendliness afforded by advanced video coding standards comes from the fact that content can be partitioned into coded slices, compatible with chunks for streaming. This makes them suitable for transmission over packet networks or for use in packet-orientated multiplex environments. According to most advanced video coding standards a video picture may be partitioned into one or more slices. A slice is a self contained sequence of macroblocks. It is a spatially distinct region of a frame that is encoded separately from any other region in the same frame. A macroblock is a basic processing unit in the video compression domain. It may be a matrix of pixels or a combination of luminance and chrominance samples for example. At the network abstraction layer, the video coding layer is mapped to transport layers. The network abstraction layer has units, which are self contained and independently decodable. In some standards, such as AVC, HEVC, these independently decodable units are known as network abstraction layer units (NALU or NAL units). An NALU comprises a unit header and a unit payload.

Different types of independently decodable units may exist in a video coded bitstream. One type of independently decodable unit relates to a slice of the video. This type is generally is known as a coded slice type. Each of this type of independently decodable units encapsulates a slice of the compressed video, a slice being a sequence of macroblocks. The unit header contains information, among others, describing the spatial position of the unit within the frame. In AVC, the spatial position of the unit is usually given as the spatial position of the first macroblock in the respective slice. Other types of independently decodable units include Sequence Parameter Set units (SPS) and Picture Parameter Set units (PPS). These types of network abstraction layer units decouple information relevant to more than one slice from the media stream and contain information such as picture size, optional coding modes and macroblock to slice group mapping. An active Sequence Parameter Set remains unchanged, and therefore valid, throughout a coded video sequence, while an active Picture Parameter Set remains unchanged, and therefore valid, within a coded picture. SPS and PPS type NALUs can therefore be said to comprise information relative to multiple sequences of macroblocks in the slices over which they remain valid.

According to embodiments of the present invention, in order to insert a mark representative of a predetermined mark pattern, the mark comprising a predetermined spatial configuration of one or more marking points into at least one video frame, each marking point appearing at a marking site having a given spatial position in the video frame, one or more special marking units having the same format as the independently decodable units is inserted into the compressed video, each marking unit comprising information which gives rise to its corresponding marking point in the video frame to appear at a given spatial position within the video frame. The information allows for the spatial position of the marking point to be calculated based on the spatial position of the slice of the video frame in which it appears and the spatial position of a region of the corresponding predetermined mark pattern. This allows for marking points to have spatial positions relative to the spatial position of an independently decodable unit within the compressed content. The spatial positions of the marking points are arranged to display a mark representing the predetermined mark pattern.

Although a marking unit having a size of one compressed macroblock would produce a minimum disturbance to the video when it is uncompressed and displayed, embodiments of the present invention may use marking units which have a size of one or more compressed macroblocks. Rendering of the inserted marking points, produced by the presence of the inserted marking units, is determined by the scanning order which is used for the video display unit. Generally a horizontal scanning order is used, resulting in successive marking points being rendered in the horizontal scan order in units of one macroblock at a time. Other scan orders are however possible.

According to embodiments, invisible or substantially imperceptible marks can be introduced by inserting marking units of type B or type P, which are predictive types of marking units comparable to predictive types of independently decodable units. Predictive types of independently decodable units relate to P-slices or B-slices, which comprise P-macroblocks or B-macroblocks, respectively, predicted using information from one or more other frames (sometimes called reference frames). According to embodiments, a visible or perceptible mark may be introduced by inserting marking units of type I, having a format of an I-slice comprising I-macroblocks relative to intraframe slices.

Embodiments of the present invention may be used to insert a mark into a video content which has been compressed according to an AVC standard (H.264) as mentioned above. Another example of an advanced video coding standard with which embodiments of the present invention are compatible is H.265. In these standards the independently decodable units are known as network abstraction layer units (NALU). Any video coding standard which allows for the chrominance and luminance characteristics of at least one spatially distinct part of a video image frame to be expressed by an independently decodable unit can be taken to be an advanced video coding standard in the context of the present disclosure.

A compressed video content which has been marked according to any of the embodiments of the present invention is said to be compatible with an advanced video coding standard as defined above whenever that standard specifies that the compressed video content should have at least one network abstraction layer unit per slice. The fact that embodiments of the present invention result in marked compressed video content having added marking network abstraction layer units as well as the corresponding network abstraction layer units of a corresponding unmarked version of the video, does not render the marked compressed video incompatible with the standard. Marked compressed video content according to embodiments of the present invention effectively introduce a new slice for each marking unit which is added. The inserted marking units are simply treated as NALUs associated with new (usually small) slices inserted into the frame, so further processing of the marked content can be continued according to the standard. Marked video content according to any embodiment of the present invention is therefore readily compatible with a system configured to process content compressed according to advanced video coding standards.

FIG. 2 shows a media player (PL), comprising a receiver (RX) for receiving video content compressed (CT_{c}) according to an H.264 or H.265 standard, in which an embodiment of the present invention may be deployed. The media player (PL) comprises an insertion module (IM) for inserting a mark into the compressed content (CT_{c}), a decoder (DEC) for decompressing the marked compressed content and a display module (DISP) to display the marked video content. Although the media player of FIG. 2 is shown to have an integrated display module the embodiment is equally compatible with media players having an external display module. According to some embodiments, the media player may also have a memory (MEM) for storing insertion data corresponding to parts of the mark to be inserted or information allowing for the positions of the marking points to be determined for example. In other embodiments such information may be provided from outside of the media player. The media player (PL) further comprises a parser (PRS) for parsing the received compressed video content to find or otherwise locate the first NALU in the received bitstream. Once located, the parser may read and analyse the header of the first NALU. During analysis the parser reads the value representing its spatial position i.e. the address of its first macroblock. Usually, since it is the first NALU, the value should be zero, meaning that the first macroblock of the first NALU is at position zero (the first position) in the frame. The first macroblock in a slice may be said to spatially identify the position of the slice within its frame. Using this same mechanism of locating and analysing NALUs, the positions of any or all of the NALUs within the frame can be found. The parser goes on to identify the next NALU in the same frame (if there is one). By analysing the header of any NALU, the parser then knows which type of macroblocks are in the respective NALU (whether they relate to an intra-slice (I), or an inter-slice such as a P or Bi-direction slice (P, B)) and it knows the spatial position of the first macroblock of the NALU. Thus, the parser is able to determine the type and the spatial position of the next NALU. By repeating this process all NALUs in the frame may be found and analysed as described above. The inserter may then insert one or more marking NALUs just before or just after the NALU being analysed. The end of one NALU is calculated as being just before the NALU which follows. The parser may then find a still further NALU in the frame if it exists and insert another one or more marking NALUs as the predetermined mark pattern dictates before or after the still further NALU, and so on until the predetermined mark pattern is completed. The procedure may be repeated again for one or more further frames to repeatedly insert marks representative of the same mark pattern in the further frames or to insert marks representative of other mark patterns.

In general terms, any of the functions carried out by the decoder, the parser and/or the receiver may be carried out by a suitably configured general processor. In some embodiments the processor may also be configured to perform the insertion module functions described above.

In the procedure described above, any predetermined mark pattern can be spatially represented in a decompressed video content by inserting one or more marking units into the bitstream of the corresponding compressed video. After being decoded, each of the inserted marking units gives rise to an additional shape (usually a rectangle) which can be seen to float above a given part of the displayed video. The spatial position of the additional shape may be calculated based on the spatial position of the slice within which the marking unit was inserted (i.e. the spatial position of its first macroblock).

If a frame has only one slice, then it is simple to add as many marking NALUs as required by the mark pattern by inserting the marking units after the first NALU of the frame to be marked. As with regular independently decodable units (NALUs), the spatial position of a marking unit is determined by an appropriate field of its unit header. It can therefore be arranged for the spatial position of a marking unit to represent a part of the predetermined mark pattern by suitably modifying an appropriate field of its header to reflect a corresponding spatial position within its frame. The spatial position is given in terms of macroblock units. According to some embodiments, information allowing for the spatial positions representing parts of the predetermined mark pattern is provided to the media player, whereas according to other embodiments the spatial positions of the marking points is calculated or otherwise generated by the media player. Dynamic generation of the spatial positions is of particular use when it is desired to produce an obfuscated video display for example.

When there is more one slice in a frame, the marking NALUs are to be inserted after the first NALU for each of the parts of the mark pattern whose corresponding marking points appear in the first slice; marking NALUs are to be inserted after the second NALU for each of the parts of the mark pattern whose corresponding marking points appear in the second slice; and so on.

When inserting the marking NALUs, the following principles are to be respected: the ascending order of the spatial positions of the first macroblocks in each of the slices in a frame is to be respected; and the spatial positions of the inserted marking points brought about by their corresponding marking units are arranged to correspond to given parts of the predetermined mark pattern such that a mark representing the predetermined mark pattern is displayed on the decoded video (usually “floating” on top).

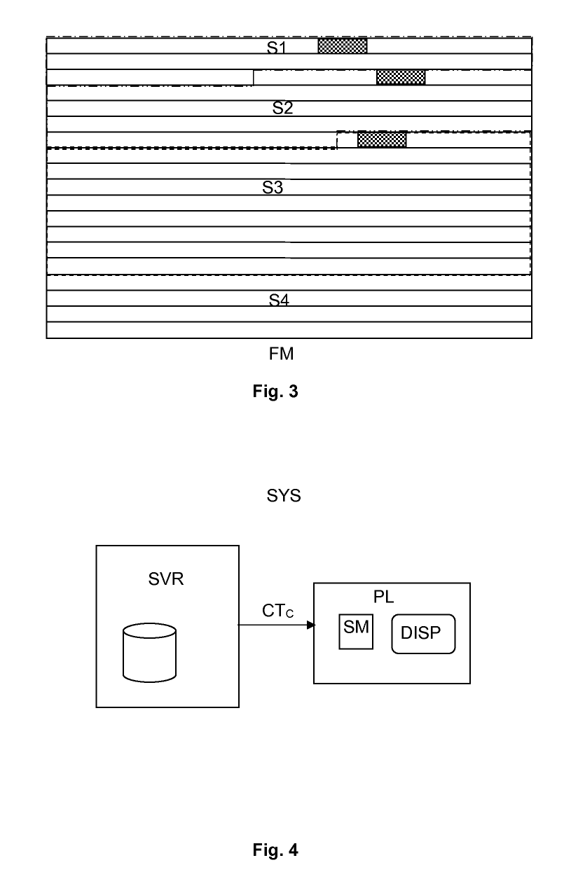

FIG. 3 illustrates a video frame partitioned into four slices with three marking points overlayed on the video, brought about by three marking NALU's having been inserted according to an embodiment of the present invention. In this example one marking NALU has been inserted into each of the first, second and third slices. In another example, more than one marking NALU could be inserted into the same slice should the predetermined marking pattern so require. Marking NALUs have a minimum size of one macroblock. A marking NALU having a size of one macroblock would present the least disturbance to the final decompressed video once its corresponding marking point is displayed. In embodiments of the present invention it is possible for marking NALUs to have a size of more than one macroblock. When marking points are intended to be of invisible type it is preferable to reduce the size of the marking NALUs accordingly.

As part of the process of insertion of the marking NALUs, the insertion module ensures that the first macroblock in slice indicator in the header of the marking NALUs properly reflect the spatial positions of the parts of the predetermined mark pattern which their corresponding marking points are intended to represent and it also ensures the ascending order of the first macroblock in slice per frame in the stream. The spatial position is usually given in terms of numbers of macroblocks. For example, the spatial position of the first macroblock in a slice is 0, while the spatial position of the 17^{th} macroblock would be 16. This numbering usually continues through any subsequent slices in the frame. Numbering in this fashion facilitates the task of the renderer since there will be no duplication of position numbers and the correct order is readily determinable.

The insertion module also ensures that the correct type of marking NALU is inserted, taking into account the type of frame (I, P or B) that is being processed and whether all or part of the inserted mark should be visible or invisible. The marking NALU should preferably be of the same type as the frame into which the marking point is being inserted. For invisible marks it is preferable to use marking units of type P or B, while for visible marks it is preferable to use marking units of type I. According to one embodiment, the marking units may be generated by the media player. According to another embodiment, the marking units may be downloaded into the media player and stored for later use. The predetermined marking pattern may be preloaded into a memory of the media player, in which case the instructions for determining the spatial positions of the marking points may be generated within the media player. Alternatively, the instructions for deriving the spatial positions of the marking points or the positions of the marking points themselves may be delivered to the media player, thereby allowing the media player and its insertion module to operate properly without prior knowledge of the predetermined marking pattern. The instructions preferably also specify the type of marking units to be inserted. The instructions, or the marking point spatial positions, may appear in the bitstream along with the content. Alternatively, the receiver may have a separate channel on which to receive the instructions or marking point spatial positions. The different types of marking unit may be pre-loaded into the media player to be copied and edited as required.

FIG. 4 shows a system (SYS) in which an embodiment of the present invention may be deployed. The system comprises a media player (PL), similar to the media player of FIG. 2, and a media server (SVR) from which the media player (PL) receives the compressed video content (CT_{c}) for marking and displaying. In this embodiment, the marking units may be downloaded from the media server to the media player. The media player then copies the marking unit when it is required or otherwise instantiates a copy of the marking unit. The insertion module updates the header of the marking unit according to where it is to be placed in the video frame being marked and possibly according to the type of marking unit required. Alternatively, in other embodiments, the marking units may be generated in the media player as and when they are needed (inserted). The instruction on where to insert a marking unit and which type of marking unit to insert is based on the predetermined mark pattern and may come from the media server if it is not generated within the media player. As shown in FIG. 4, a media player configured according to an embodiment of the present invention may further comprise a security module. The security module may be used to descramble the content or to provide encryption keys allowing for the descrambling of the content. According to some embodiments, the security module may be configured to perform or otherwise secure the performance of the mark insertion function. When the security module performs the mark insertion function, advantage is to be gained by the fact that the security module already securely stores identifying credentials which it may already use as part of the descrambling process. It is therefore convenient to be able to use those credentials or information based or otherwise derived therefrom to generate all or part of the mark to be inserted. The fact that this is done within the security module provides for a secure insertion function because there is no risk of leaking of secure information. Furthermore, thanks to certain integrity checks which are possible using the security module, it is not easy for a malicious party to simply bypass the insertion function.

According to an embodiment, commands are received by the media player from the server or some head-end entity with respect to the spatial positions of the mark points of the marking pattern and the media player then generates marking units of the required type (depending on visibility of the resulting mark pattern) as and when they are required.

According to another embodiment, instead of pre-generating marking units in the media player or downloading marking units from the server, the media player is configured to create a marking unit based on the original independently decodable unit found by the parser. In this manner, the same type of marking unit as the original NALU is generated and the insertion module simply has to adjust the value of the indicator of the first macroblock in the slice to reflect the position of the inserted marking point within the frame. However, this procedure, which effectively creates two identical slices, one overlaid above another, offset from one another according to the adjustment described above, generally degrades the final video frame to an extent which is proportional to the size of the slice. This procedure is therefore only recommended when the original size of the slice is relatively small.

The minimum size of a marking NALU is one macroblock unit. With this size, methods according to embodiments of the present invention produce the minimum disturbing effect to a viewer of the marked video content. By way of example, a minimum size of a marking point produced by a marking NALU of minimum size could be a black square having a size of one macroblock, which could be, say, 16×16 pixels. The colour of the marking point need not be black however—this will be further discussed below.

The resulting mark pattern which appears in the video content displayed through a processes according to any of the embodiments of the present invention may be arranged to represent an identifiable parameter (for example a unique ID) of the media player or a component thereof. This would generally be the case where the mark pattern is a fingerprint, traceable to the media player. Alternatively, in cases where the mark is of a watermark type, the predetermined mark pattern preferably represents an identifier of the media server or a component thereof or an identifier of the content owner. According to embodiments, a transformation of any of these identifiers may be made to provide anti-collusion capability or error correcting capability, compatible with known anti-collusion codes or error correcting codes.

A system in which another embodiment of the present invention may be deployed may comprise a plurality of media players. In such systems, it may be arranged for the mark pattern to be a combination of sets of marking points from each of the media players.

There now follows a more detailed description of how marks can be embedded into video content according to embodiments of the present invention and how such marks, once detected, may be interpreted.

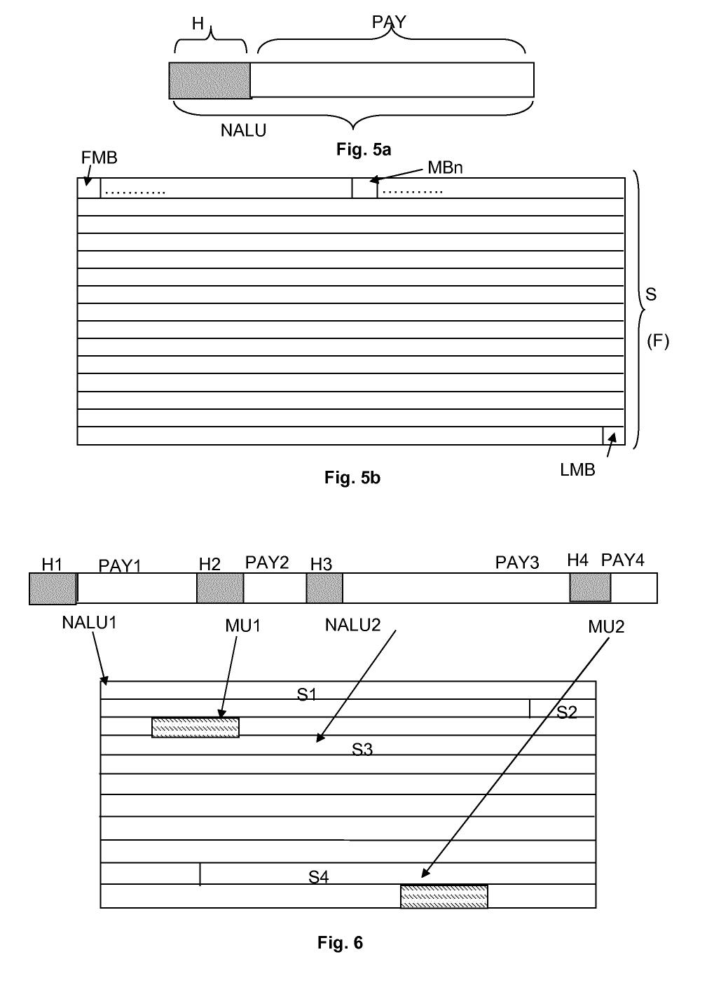

It has already been mentioned that a video frame comprises one or more slices. In the compressed domain, a slice can be represented by a NALU, which is an independently decodable unit representing the chrominance and luminance information, which when decompressed will allow for the video content of the respective slice to be reconstructed. FIG. 5a shows a schematic representation of an independently decodable unit according to an advanced video coding standard. In this case it is a network abstraction layer unit (NALU) as described in the H.264 or H.265 advanced video coding standards. The NALU is shown to comprise a unit header and a unit payload. Different types of NALU exist. The unit header (H) contains, among others, information about the type of unit or slice. The unit header also contains information about the spatial position of the NALU and hence the spatial position of the first macroblock in the respective slice. In some types of NALU the unit payload (PAY) comprises a sequence of macroblocks making up the slice. FIG. 5b illustrates the spatial information that is carried by the NALU of FIG. 5a. If a frame of video had only one slice, then the NALU represented by FIG. 5a (bitstream) would comprise information for the reconstruction of a complete frame and FIG. 5b would be the spatial representation of that frame. The frame therefore has a first macroblock (FMB) at position 0 followed by a sequence of other macroblocks (one such macroblock (MBn) is shown around position 11) and ending with a last macroblock (LMB). Since there is only one slice (S) in this frame this describes the complete frame (F).

A frame may also be composed of a plurality of slices compressed into a plurality of NALUs in the compressed domain as shown in FIG. 6, showing a part of the compressed bitstream and the spatial representation of the resulting marking points in the corresponding frame. A frame having a single slice presents a simple case for mark pattern insertion according to embodiments of the present invention since as many marking units as required by the corresponding mark pattern points can be inserted directly after the original NALU of the video frame, with the spatial positions of the inserted marking NALUs being edited to reflect their respective spatial positions on the video frame. When more than one slice is present, care has to be taken to insert the marking NALUs after the correct NALU whose slice incorporates the points of the marking pattern to be reflected by the inserted marks. When the frame has more than one slice, one or more MNALUs are inserted after each of the NALUs according to where the corresponding marking points are to appear in the displayed video. For example, if part of the predetermined mark pattern falls within the first slice, then the MNALUs which will lead to the appearance of marking points corresponding to those parts of the predetermined mark pattern which fall into the first slice will be inserted after the first NALU. If part of the predetermined mark pattern falls within the second slice, then the MNALUs which will lead to the appearance of marking points corresponding to those parts of the predetermined mark pattern which fall into the second slice will be inserted after the second NALU, and so on.

Thus, it is possible to generate marks according to embodiments of the present invention. Such marks comprise one or more marking points appearing on a video frame. The mark may be repeated on subsequent frames or at intervals over any of the following frames. A code may comprise one or more symbols—a string of symbols for example. By arranging for a code to reflect an identifier a code can represent an identifier. For example, a code may be 010001, which is a string of 0 or 1 symbols. A code may be 80ABF, with the symbols being hexadecimal symbols. Symbols may be alphanumeric symbols or binary symbols. As described below, embodiments of the present invention allow for marks to represent one or more symbols (in this example. the predetermined mark pattern is one or more symbols) and by changing symbols from one frame to another it is possible to build up codes which will form the fingerprint or watermark.

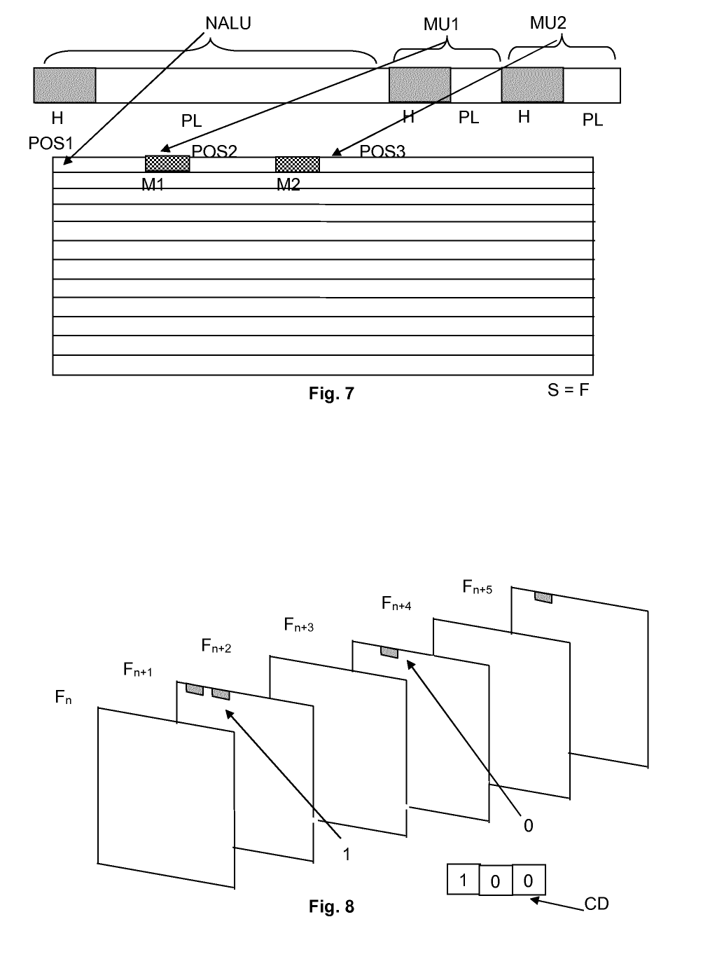

The top part of FIG. 7 shows part of a compressed bitstream which has been processed according to an embodiment of the present invention. This part of the compressed bitstream represents a frame. In this example, for simplicity, the frame has only one slice. The processed part of the bitstream of compressed video has had two marking units (MU) inserted. A first marking NALU (MU1) has been inserted directly after the first NALU of the frame (which is the only NALU of the frame since it has only one slice) and a second MNALU (MU2) has been inserted directly after the first marking unit (MU1). For this example we assume that this part of the bitstream corresponds to the n^{th} frame of the video sequence. Since all frames of the video sequence only have one slice, it follows that the n^{th} frame of the video sequence can be marked by finding the n^{th} NALU (belonging to the Video Coding Layer) of the bitstream representing the video sequence in the compressed domain and inserting one or more marks after the n^{th} NALU. Once decoded, the compressed bitstream, marked as described above, will yield a video sequence having its n^{th} frame marked by two rectangular shapes floating over part of the picture, as illustrated in the bottom part of FIG. 7. The spatial positions of the inserted marks in the video frame are determined by a field of the header of each of the corresponding MNALUs. Appropriate edition therefore of these headers is sufficient to ensure that the marks appear in the video at the positions required by the predetermined marking pattern. In FIG. 7, the NALU is the only one in the frame since the frame (F) has one slice (S) and the value of the first macroblock in the slice is 0, which lies at a first position in the frame (POS1). The first inserted marking unit (MU1) corresponds to a second point (POS2) in the frame and the second inserted marking unit (MU2) corresponds to a third position (POS3) in the frame. In this manner, selected frames from the video sequence can be marked with one or more marking units in the compressed video bitstream to give a final mark pattern comprising one or more rectangle shaped marks on the corresponding frames of the displayed video once it has been decoded.

According to an embodiment of the invention, a predetermined coding syntax is established where a particular arrangement of one or more rectangle shapes (representing the mark pattern here) on a video frame corresponds to a symbol. A sequence of such symbols can be generated by taking into account a series of successive video frames. This is illustrated in the simplified example shown in FIG. 8, where it has been established that a frame having two rectangle shapes inserted represents a symbol 1 and a frame having one rectangle shape inserted represents a symbol 0. By marking various frames with one or other of these symbols, a full identifier can be built up over the course of a number of marked frames. It is also possible to establish a period, the period representing the rate at which frames are marked. For example if the period were 1 then every consecutive frame would be used to convey the symbol. If the period were 2, then every other frame would be used to convey the symbol. In FIG. 8, the period (T) is 2 and so it is expected that every second frame provides a symbol. Using this technique it is possible to code a unique identifier having n bits over a sequence of video comprising 2×n frames.

Using symbols to form codes as described above allows for less visible marking to be achieved since the number of inserted marking points per frame can be somewhat low while still allowing for identifiers to be embedded into the video for watermarking or fingerprinting purposes. On the other hand, where visibility or distortion are not of concern or of less concern, then it is possible to send complete identifiers or at least complete codes (all symbols and therefore all shapes of their pattern) in one frame. For instance if each (binary) symbol can be represented by a 1 shape (green rectangle=symbol 1) or a 0 shape (red rectangle=symbol 0) at a predefined spatial position on a frame, then it is possible to include, say ten such shapes in the same frame. Thus, the single frame can carry a code comprised of ten symbols in embodiments of the present invention where compact insertion is used. Such compact insertion may lead to some distortion and so is of use in cases where visibility of the mark is not an issue.

Marking NALUS according to any of the embodiments of the invention can be of type I, P or B. They may be pre-generated from a small part of a reference video. For example, a reference video may be a homogeneous chrominance/luminance video comprising only 3 green images of size 16×64 pixels. The reference video may then be encoded using the following parameters: one NALU per frame; and Group of Pictures structure I B P. This produces an NALU which can be used as a marking NALU. In order to take account of the level of visibility that the resulting marks will have in a video into which they are inserted, it is also possible to pre-generate several different marking units (MNALUs) from a number of different reference videos, depending on different content criteria, such as sports video, news video, nature video, etc . . . This will give a choice of different marks which will be more or less visible when inserted into various different types of video.

The pre-generated marking NALUs may be loaded into the media player so that they are ready and available to be used at insertion time. They may be selected to be inserted before or after a NALU of the same type (I, P or B). Alternatively, a marking NALU of type I may be chosen to be inserted beside a NALU of type P or B in order to ensure that the resulting mark will be clearly visible, thus facilitating the detection of the marking pattern.

According to another embodiment of the invention, the NALU of type SPS and PPS (containing the global information for decoding the following NALUs) generated from the reference video are also inserted before each MNALU, then a NALU of type SPS and PPS of the original video are recopied after the just inserted MNALU (the last MNALU of a successive set of just inserted MNALUs). Doing so, the visual impact of MNALU is more precise for the detection later on while maintaining the correct decoding process of the original NALUs.

According to another aspect of the present invention, a system incorporating another embodiment of the present invention can be used to detect or otherwise recover a code from watermarked or fingerprinted video content without referring to the original video without the watermark or fingerprint. The system comprises a memory in which to store the predetermined marking pattern and a screen capture device such as a video camera or a memory buffer to capture and store one or more fields of a displayed video content. The system is configured to match the predetermined marking pattern with one or more frames of the captured video in order to detect whether the one or more frames contain any trace of the marking pattern. When the video content has been marked using visible marking techniques the detection may be performed by eye.

A capture device may be a digital signal processor configured to analyse redistributed content to be able to detect discontinuities in the video, thereby suggesting the possible presence of a mark. The content can then be further analysed to extract and identify the mark. For example, in content where the inserted mark is monotone green while the surrounding video has a distinctly different colour a sufficient discontinuity appears in the video to allow for it to be detected. Even when invisible type marking is used which is less detectable using the human eye, enough of a disruption is usually generated in the video to allow for digital signal processing techniques to be used to identify discontinuities caused by the insertion of marking NALUs according to embodiments of the present invention. Disruption due to insertion of marking NALUs begins at the first macroblock of the slice where the marking NALU has been inserted and ends at some point following the end of the marking NALU's slice since the following macroblocks (in the next slice) may depend on information from the marking NALU.

One method for detecting a discontinuity or disruption in a video frame, according to an embodiment of the present invention, is now described. Discontinuity may be detected by analysing the gradient of the luminance and/or chrominance components within a frame of raw video. (By raw video it means uncompressed video). A change in the gradient is considered to be of significance if the amount of change is greater than a predetermined threshold. If a significant change is detected at a predetermined spatial position corresponding to a region where a mark would be expected to appear in a video frame (with reference to the predetermined mark pattern), then a marking point is detected. It is therefore possible to check all regions of a video frame where a marking point would be expected to appear and if the gradients at all of those regions are above the predetermined threshold, then it can be said that the combination of marking points has been detected. When one or more frames are analysed and found to comprise all of the symbols making up the mark, then it can be said that the video has the mark in question. This method of detection can be said to be blind detection in the sense that it relies simply on analysis of the raw video and does not require any prior knowledge or access to a copy of the original unmarked video.

Another method for detecting discontinuities or disruptions in a video frame, according to an embodiment of the present invention, is now described. In this method the spectral coefficients of the luminance and/or chrominance components of raw video frames are analysed. Spectral coefficients of luminance and/or chrominance components may be calculated from two-dimensional transformations of the raw video signal such as (and not limited to) Fourier transformation, Direct Cosine Transformation (DCT) or orthogonal wavelet transformation. During analysis of the raw video, if a considerable change in certain predetermined frequencies is observed, then a marking point is detected. Again, such detection can be accomplished blindly. Alternatively, during analysis of the raw video, if high energies are detected at a given predetermined frequency, or group of predefined frequencies, then a marking point is detected.

1. A system for inserting at least one marking point into a video content, the marking point having a spatial position within a frame of the video content, the system comprising one or more modules including an insertion module for inserting the marking point into a compressed bitstream of the video content;
wherein the compressed bitstream of the video comprises at least one frame of the video content, the frame being divided into one or more slices each representing spatially distinct regions of the frame, each slice being encoded into an independently decodable unit, each slice having a spatial position within its frame, the spatial position of the slice being given by at least part of a header portion of the independently decodable unit;
characterised in that:
the marking point corresponds to an independently decodable marking unit in the compressed bitstream of the video content, the independently decodable marking unit having a header portion, the insertion module being configured to insert the independently decodable marking unit having a header portion at least part of which gives a spatial position of a marking slice, and to edit the header portion of the independently decodable marking unit based at least on the spatial position of the marking point.

2. The system according to claim 1, the system configured to derive a spatial position of a mark comprising a plurality of marking points from at least a part of a predetermined mark pattern.

3. The system according to claim 2, further comprising a security module having a secure memory, the system configured to derive the mark from at least one identifier stored in the security module, the identifier corresponding to at least one of the modules thus rendering the mark traceable to the system.

4. The system according to claim 1, the marking unit having a type corresponding to an independently decodable unit which is compatible with an intraframe, a resulting mark in a display of the marked content being perceptible to a human.

5. The system according to claim 1, the marking unit having a type corresponding to an independently decodable unit which is compatible with an interframe, the resulting mark being substantially imperceptible to a human.

6. The system according to claim 1 further configured to derive the marking unit from a stored copy of a reference marking unit and to adjust the header portion of the derived marking unit to correspond to the spatial position and a perceptibility of the marking point.

7. The system according to claim 6, further configured to derive the spatial position and the type of the marking unit based on a copy of the predetermined mark pattern stored in a module of the system.

8. The system according to claim 1, further comprising a receiver for receiving the compressed video content from a head-end, the system configured to derive the spatial position and/or the type of the marking unit based on a copy of the predetermined mark pattern stored in a module of the head-end.

9. The system according to claim 1, wherein the independently decodable unit and the marking unit are network abstraction layer units according to either a H.264 or a H.265 video coding standard.

10. A propagated signal comprising a bitstream representative of one or more frames of video content, the bitstream being compressed according to a video coding scheme in which at least one spatially distinct contiguous region of a video frame is comprised within a network abstraction layer unit within the bitstream;
characterised in that:
at least one frame of video decodable from at least part of the bitstream of compressed video content comprises a marking point corresponding to a marking network abstraction layer unit within the bitstream, the marking point having a spatial position in its frame which corresponds to a spatial position of part of a predetermined mark pattern.

11. The propagated signal according to claim 10, wherein the spatial position of the marking point is comprised within a header of the network abstraction layer unit, the marking unit further comprising a payload comprising one or more macroblocks of the marking point.

12. The propagated signal according claim 10, wherein the header and the payload of the marking unit comply with the video coding standard.

13. A method for causing at least one marking point to be overlaid onto a video image comprising one or more video frames divisible into one or more video slices, the marking point having a spatial position within its video frame, comprising:
inserting at least one marking unit into a bitstream corresponding to the video image, the bitstream being compressed according to a video coding scheme in which at least one spatially distinct contiguous region of the video frame is comprised within a network abstraction layer unit having a header comprising a spatial position of part of the video image and a payload comprising one or more macroblocks of the video image, the marking unit having a header comprising the spatial position of the marking point and a payload comprising at least one macroblock of the marking point.

14. The method according to claim 13, further comprising adjusting the header of the marking unit to correspond to a video slice of type intraframe or interframe depending, respectively, on whether the corresponding mark is to be perceptible or imperceptible to a human observer of the marked video image.

15. The method according to claim 13, further comprising adjusting the payload of the marking unit depending on whether the corresponding mark is to be perceptible or imperceptible to a human observer of the displayed marked video image.
